(19) United States
(12) Patent Application Publication
(10) Pub. No.: US 2007/0164494 A1
(43) Pub. Date: Jul. 19, 2007

(54) CLAMPING DEVICE FOR A CURING PROCESS

(75) Inventor: Chia Ming Chang, Pingtung City (TW)

Correspondence Address: LOWE HAUPTMAN BERNER, LLP, 1700 DIAGONAL ROAD, SUITE 300, ALEXANDRIA, VA, 22314, US

(73) Assignee: ADVANCED SEMICONDUCTOR ENGINEERING INC., KAOHSIUNG (TW)

(21) Appl. No.: 11/558,771

(22) Filed: Nov. 10, 2006

(30) Foreign Application Priority Data
Jan. 16, 2006 (TW) 095101564

(51) Int. Cl. B25B 1/20

(52) U.S. Cl. 269/43

(57) ABSTRACT

A clamping device includes an upper plate, a lower plate, a clamping body, an upward/downward moving unit and an elastically adjusting unit. The lower plate is adapted to support a product. The upward/downward moving unit is adapted to move the clamping body and the upper plate downward, whereby the upper and lower plates upward and downward press the product respectively. The elastically adjusting unit has two ends which are respectively mounted to the upper plate and the clamping body, thereby providing the upper plate with an elastic force so as to uniformly press the product.

### CROSS REFERENCE TO RELATED APPLICATION

This application claims the priority benefit of Taiwan Patent Application Serial Number 095101564, filed Jan. 16, 2006, the full disclosure of which is incorporated herein by reference.

### BACKGROUND OF THE INVENTION

1. Field of the Invention

The present invention generally relates to a clamping device, and more particularly to a clamping device including an elastically adjusting unit which can provide an upper pressing plate with an elastic force so as to uniformly press a product.

2. Description of the Related Art

During molding and encapsulating processes of semiconductor packages, a molding compound material will be used. The molding compound material can be a thermosetting plastic material. According to the yield and output of product, the curing process of the molding compound material generally includes two following steps. In the first step, molding compound material is injected and then solidified. In the second step, the product are taken away, pressed by a heavy body, put in an oven, and then are baked so as to process a post-curing process.

More detailed, in the post-curing process, the encapsulated and marked product is put in the oven and then baked. The post-curing process achieves the objective that the molding compound material is fast solidified and then is in a stable state of fully curing so as to increase the reliability of the product by using heating and backing manners. During baking process, the product, e.g. a plurality of semiconductor packages, are always pressed by the heavy body, or are always pressed and clamped by a conventional heatproof clamping device (shown in FIG. 1), thereby avoiding a warpage problem caused by the difference between expansion coefficient of multi-layer structure, the different degree of curing of the semiconductor packages, or the lack of uniformity of the injected molding compound material.

Referring to FIG. 1 again, the conventional clamping device 10 includes an upper pressing plate 12 and a lower pressing plate 14 for respectively upward and downward pressing the semiconductor packages 16. The upper pressing plate 12 is mounted on the clamping body 18 by screws or is directly mounted on the clamping body 18. Also, the upper pressing plate 12 is moved along a guiding screwed rod 24 and guiding rods 26 by using a torque wrench 22, thereby pressing the semiconductor packages 16, e.g. the pressing force is 120 kgf. However, when the components (e.g. the guiding screwed rod 24) are worn and torn, a gap 28 between the upper pressing plate 12 and the semiconductor packages 16 causes the semiconductor packages 16 to have uneven pressed area (shown in FIG. 2) so as to decrease the ability of the clamping device to overcome the warpage of semiconductor packages.

Furthermore, referring to FIG. 1 again, the clamping device 10 further includes a separable plate set for separating semiconductor packages 16 from each other. The separable plate set includes an upper separable plate 32, a lower separable plate 34, and a plurality of intermediate separable plates 36 which are disposed between the upper separable plate 32 and the lower separable plate 34. The semiconductor packages 16 are disposed between the upper separable plate 32 and the intermediate separable plate 36, the intermediate separable plates 36, and the intermediate separable plate 36 and the lower separable plate 34 in sequence.

For example, referring to FIG. 3, it depicts an exploded schematic view of two semiconductor packages 16 and a separable plate set, when two semiconductor packages 16 are clamped. The upper separable plate 32 and the lower separable plate 34 are respectively constituted by steel plates 42, 46 with a thickness of 5 mm and glass plates 44, 48 with a thickness of 5 mm. Also, the upper separable plate 32 and the lower separable plate 34 respectively contact the upper pressing plate 12 and the lower pressing plate 14 of the clamping device 10. The intermediate separable plates 36 are stainless steel sheets with a thickness of 0.3 mm, whereby the semiconductor packages 16 cannot be adhered to each other. However, the stainless steel sheets are soft, and thus the stainless steel sheets will be deformed in accordance with some warped semiconductor package.

Accordingly, there exists a need for a clamping device and a clamping method capable of solving the above-mentioned problems.

### SUMMARY OF THE INVENTION

It is an object of the present invention to provide a clamping device including an elastically adjusting unit which can automatically adjust the necessary elastic force, thereby providing an upper pressing plate with an elastic force so as to uniformly press a product.

In order to achieve the foregoing object, the present invention provides a clamping device including an upper pressing plate, a lower pressing plate, a clamping body, an upward/downward moving unit and an elastically adjusting unit. The lower plate is adapted to support a product. The upward/downward moving unit is adapted to move the clamping body and the upper pressing plate downward, whereby the upper and lower pressing plates upward and downward press the product respectively. The elastically adjusting unit has two ends which are respectively mounted to the upper pressing plate and the clamping body, thereby providing the upper pressing plate with an elastic force so as to uniformly press the product.

The elastically adjusting unit can automatically adjust the necessary elastic force, whereby the upper pressing plate can fully flatly and uniformly press the product. The elastically adjusting unit provides the pressing upper plate with the elastic force so as to uniformly press the product and thus to increase the ability of the clamping device to overcome the warpage of product after heating.

The foregoing, as well as additional objects, features and advantages of the invention will be more apparent from the following detailed description, which proceeds with reference to the accompanying drawings.

### BRIEF DESCRIPTION OF THE DRAWINGS

FIG. 1 is a perspective schematic view of a clamping device in the prior art, showing that the clamping device clamps a plurality of semiconductor packages.

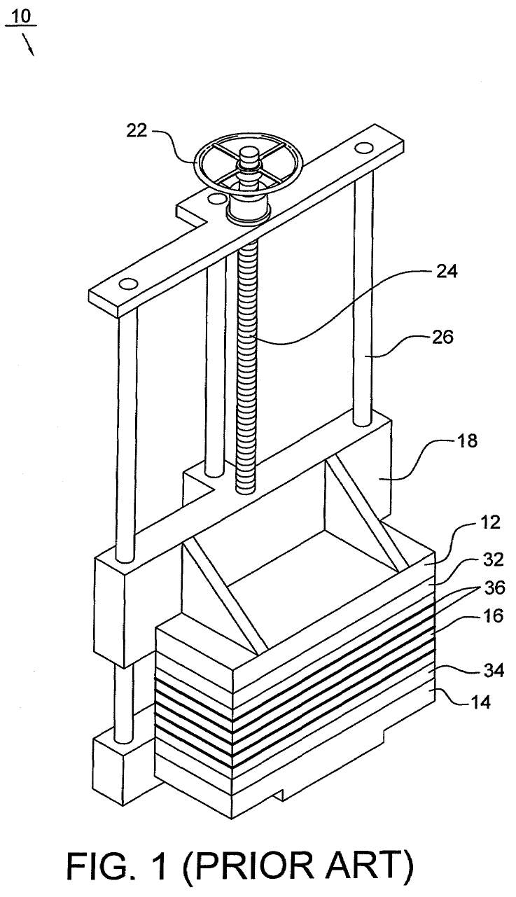

FIG. 2 is a sectional schematic view of a clamping device in the prior art, showing a gap between the upper pressing plate and the semiconductor packages.

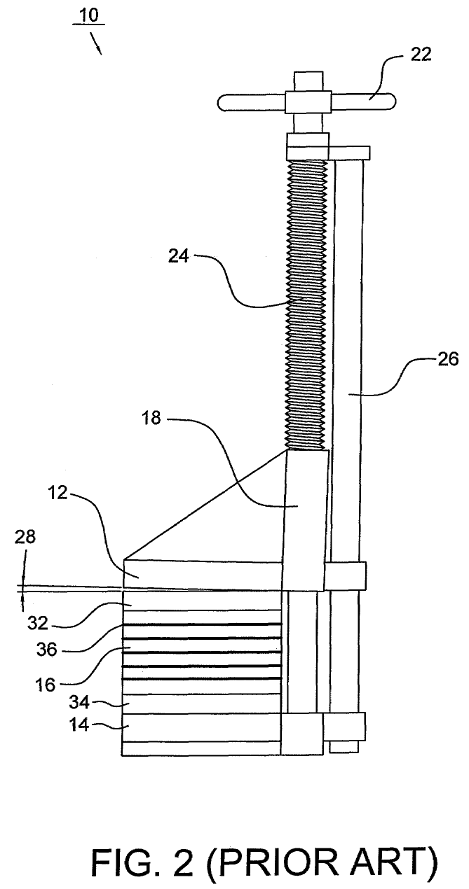

FIG. 3 is an exploded schematic view of two semiconductor packages and a separable plate set in the prior art.

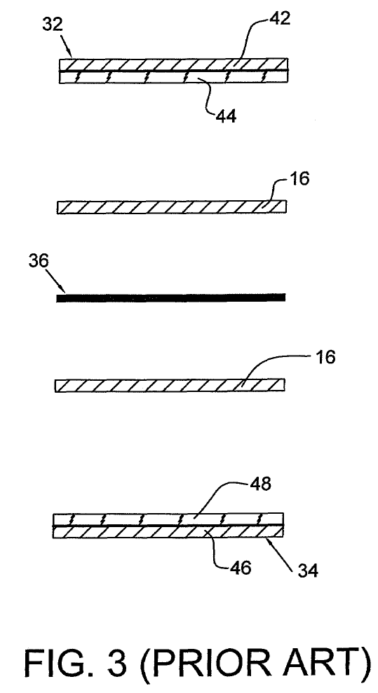

FIG. 4 is a perspective schematic view of a clamping device according to an embodiment of the present invention, showing that the clamping device clamps a plurality of semiconductor packages.

FIG. 5 is a sectional schematic view of a clamping device according to the embodiment of the present invention, showing that there is no gap between the upper pressing plate and the semiconductor packages.

FIG. 6 is an exploded schematic view of two semiconductor packages and a separable plate set of the present invention.

### DETAILED DESCRIPTION OF THE PREFERRED EMBODIMENT

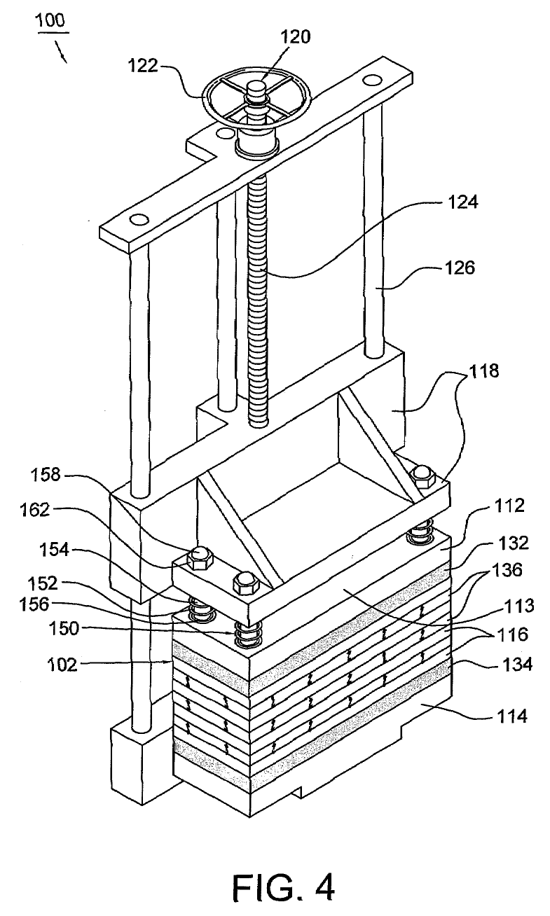

Referring to FIG. 4, it depicts a clamping device according to an embodiment of the present invention. The clamping device 100 is applied to the curing process of a product 102 (e.g. a plurality of semiconductor packages 116 which have a molding compound material), i.e. the clamping device 100 is adapted to press the cured molding compound material of the product. The clamping device 100 includes an upper pressing plate 112, a lower pressing plate 114, an elastically adjusting unit 150, a clamping body 118 and an upward/downward moving unit 120. The lower pressing plate 114 is adapted to support the product 102 to be heated. The upward/downward moving unit 120 is adapted to move the clamping body 118 and the upper pressing plate 112 downward, whereby the upper and lower pressing plates 112, 114 are upward and downward press the product 102 respectively. For example, the clamping body 118 and the upper pressing plate 112 is moved along a guiding screwed rod 124 and at least one guiding rod 126 by using a torque wrench 122 of the upward/downward moving unit 120, thereby pressing the product 102, e.g. the pressing force is 120 kgf.

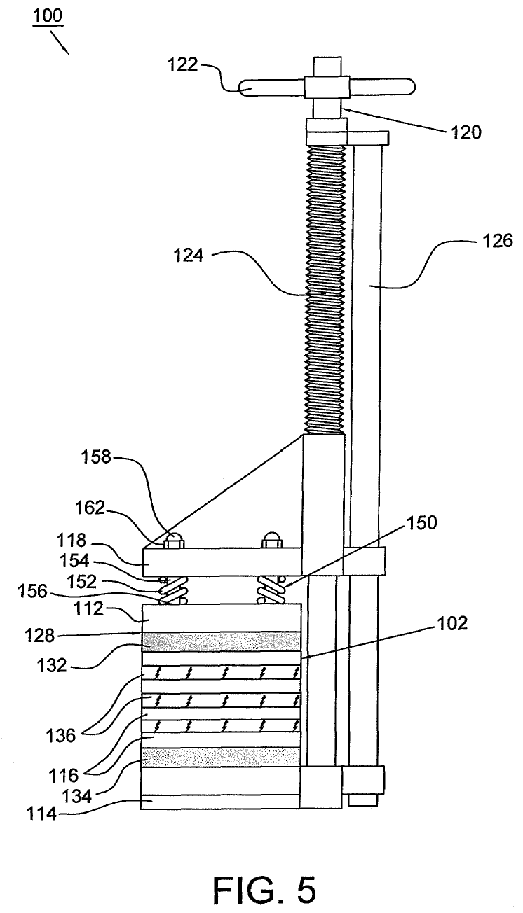

Two ends of the elastically adjusting unit 150 are respectively mounted to the upper pressing plate 112 and the clamping body 118, whereby the upper pressing plate 112 can efficiently and uniformly press the product 102, and there is no gap 128 between the upper pressing plate 112 and the product 102 (shown in FIG. 5). The elastically adjusting unit 150 includes at least one elastic element 152, e.g. a heatproof (at 200 degrees centigrade) spring. Preferably, the elastically adjusting unit 150 includes four elastic elements 152, which are disposed between the upper pressing plate 112 and the clamping body 118 and are located at four corners of the surface 113 of the upper pressing plate 112. The elastic element 152 can automatically adjust the necessary elastic force, whereby the upper pressing plate 112 can fully flatly and uniformly press the product 102. The elastically adjusting unit 150 provides the pressing upper plate 112 with the elastic force so as to uniformly press the product 102 and thus to increase the ability of the clamping device 100 to overcome the warpage of product 102 after heating.

The elastically adjusting unit 150 further includes at least one guiding rod 154, which is disposed in the elastic element 152 for guiding the pressing upper plate 112 to move in the compressing direction. The first end 156 of the guiding rod 154 is mounted to the pressing upper plate 112, the guiding rod 154 passes through the clamping body 118, and the second end 158 of the guiding rod 154 projects from the clamping body 118, e.g. the second end 158 can be 7 mm. The second end 158 of the guiding rod 154 is provided with a nut 162 for adjusting the initial elastic force of the elastic element 152, e.g. the initial elastic force can be 88 kgf.

Furthermore, a clamping method of the present invention can be applied to a curing process of a molding compound material of a product 102. The clamping method includes the following steps. Firstly, a clamping device 100 is provided, wherein the clamping device 100 includes an upper pressing plate 112 and a lower pressing plate 114, and the lower pressing plate 114 is adapted to support the product 102. Then, the upper pressing plate 112 is downward moved. Finally, an elastic force is provided, whereby the upper pressing plate 112 uniformly presses the product 102. The clamping device 100 further includes a clamping body 118, an upward/downward moving unit 120 and an elastically adjusting unit 150. The upward/downward moving unit 120 is adapted to downward move the clamping body 118 and the upper pressing plate 112, whereby the upper and lower pressing plates 112, 114 are upward and downward press the product 102 respectively. Two ends of the elastically adjusting unit 150 are respectively mounted to the upper pressing plate 112 and the clamping body 118, thereby providing the pressing upper plate 112 with the elastic force so as to uniformly press the product 102.

In addition, referring to FIG. 4 again, the clamping device 100 further includes a separable plate set for separating semiconductor packages 116 from each other. The separable plate set includes an upper separable plate 132, a lower separable plate 134, and a plurality of intermediate separable plates 136 which are disposed between the upper separable plate 132 and the lower separable plate 134. The semiconductor packages 116 are disposed between the upper separable plate 132 and the intermediate separable plate 136, the intermediate separable plates 136, and the intermediate separable plate 136 and the lower separable plate 134 in sequence.

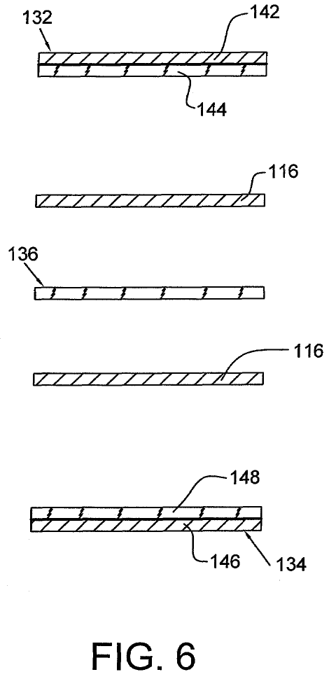

For example, referring to FIG. 6, it depicts an exploded schematic view of two semiconductor packages 116 and a separable plate set, when two semiconductor packages 116 are clamped. The upper separable plate 132 and the lower separable plate 134 are respectively constituted by steel plates 142, 146 (e.g. the steel plates with a thickness of 5 mm) and glass plates 144, 148 (e.g. the glass plates with a thickness of 5 mm). Also, the upper separable plate 132 and the lower separable plate 134 respectively contact the upper pressing plate 112 and the lower pressing plate 114 of the clamping device 100. The intermediate separable plates 136 can be glass plates (e.g. the glass plates with a thickness of 5 mm), whereby the semiconductor packages 116 cannot be adhered to each other, and the glass plates won't be deformed in accordance with some warped semiconductor package.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A clamping device comprising:
an upper pressing plate;
a lower pressing plate adapted to support a product;
a clamping body;
an upward/downward moving unit adapted to move the clamping body and the upper pressing plate downward, whereby the upper pressing plate upward presses the product and lower pressing plate downward presses the product respectively; and
an elastically adjusting unit having two ends which are respectively mounted to the upper pressing plate and the clamping body, thereby providing the upper pressing plate with an elastic force so as to uniformly press the product.

2. The clamping device as claimed in claim 1, wherein the upward/downward moving unit includes a guiding screwed rod, at least one first guiding rod and a torque wrench, whereby the clamping body and the upper pressing plate are moved along the guiding screwed rod and the guiding rod so as to press the product.

3. The clamping device as claimed in claim 1, wherein the elastically adjusting unit includes at least one elastic element, which is disposed between the upper pressing plate and the clamping body and is located on a surface of the upper pressing plate.

4. The clamping device as claimed in claim 3, wherein the elastically adjusting unit includes four elastic elements, which are disposed between the upper pressing plate and the clamping body and are located at four corners of the surface of the upper pressing plate.

5. The clamping device as claimed in claim 3, wherein the elastic element is a spring.

6. The clamping device as claimed in claim 5, wherein the spring is a heatproof spring at 200 degrees centigrade.

7. The clamping device as claimed in claim 3, wherein the elastically adjusting unit further includes at least one second guiding rod, which is disposed in the elastic element for guiding the pressing upper plate to move in a compressing direction.

8. The clamping device as claimed in claim 7, wherein a first end of the second guiding rod is mounted to the pressing upper plate, the second guiding rod passes through the clamping body, and a second end of the second guiding rod projects from the clamping body.

9. The clamping device as claimed in claim 8, further comprising a nut disposed at the second end of the second guiding rod for adjusting the initial elastic force of the elastic element.

10. The clamping device as claimed in claim 1, wherein the clamping device is adapted to press the product which is a plurality of semiconductor packages.

11. The clamping device as claimed in claim 1, further comprising a separable plate set adapted to separate the product which is a plurality of semiconductor packages from each other, and including an upper separable plate, a lower separable plate and a plurality of intermediate separable plates which are disposed between the upper separable plate and the lower separable plate, wherein the intermediate separable plates are glass plates.

12. The clamping device as claimed in claim 1, wherein the product has a molding compound material, and the clamping device is adapted to press a cured molding compound material of the product.
